(19) United States
(12) Patent Application Publication
(10) Pub. No.: US 2025/0206057 A1
(43) Pub. Date: Jun. 26, 2025

(54) SHEET PROCESSING APPARATUS

(71) Applicant: HUNKELER AG, Wikon (CH)

(72) Inventors: Patrick FAES, Zofingen (CH); Thomas SCHÜRCH, Murgental (CH); Ruedi WACKER, Zofingen (CH)

(73) Assignee: HUNKELER AG, Wikon (CH)

(21) Appl. No.: 18/976,886

(22) Filed: Dec. 11, 2024

(30) Foreign Application Priority Data
Dec. 21, 2023 (CH) CH001457/2023

(51) Int. Cl. B42C 19/02; B42C 1/12; B42C 9/00; B65H 45/30

(52) U.S. Cl. CPC B42C 19/02; B42C 1/12; B42C 9/0081; B65H 45/30; B65H 2301/3322; B65H 2301/4312; B65H 2301/5151; B65H 2301/5152; B65H 2511/10; B65H 2511/20; B65H 2557/30; B65H 2801/48

(57) ABSTRACT

A sheet processing apparatus for producing book blocks from printed single sheets includes a conveying section for conveying a printed single sheet along a conveying direction, an input section configured to receive the printed single sheet, a control system configured to generate a workflow order comprising one or more commands for processing the printed single sheet, a sheet sensor configured to detect a sheet parameter having at least one of position and size of the printed single sheet, a sheet rotator configured to stop the printed single sheet and to rotate the printed single sheet or to convey the printed single sheet without rotation depending on a rotation command of the workflow order, a perforator configured to perforate the printed single sheet, and a folding device configured to fold the printed single sheet.

### FIELD OF THE INVENTION

The present invention relates to a sheet processing apparatus for producing book blocks from printed single sheets, a book block production apparatus comprising a sheet processing apparatus, a method of producing book blocks from printed single sheets using a book block production apparatus and a method of processing printed single sheets for producing book blocks therefrom using a sheet processing apparatus.

### BACKGROUND OF THE INVENTION

Book blocks comprising stacks of printed sheets are typically manufactured in book block production lines where different processing steps like printing, cutting, folding, gluing, stacking, aligning etc. may be executed. Books are for example manufactured in book block production lines with digital printing on a continuous paper web, with the book production line comprising an unwinding and printing station and other kinematic components including e.g. a perforating and cutting station, a dynamic signature forming station and a collecting and pre-assembling station.

EP 2 159 070 B2 describes for example an apparatus for producing stacks which form book blocks having an unwinding station, in which a material web to be processed is unwound from a reel, and a digital printing station, in which the material web is printed on both sides. A perforating station connected behind the digital printing station, which perforating station has a perforating unit, by means of which the printed material web can be provided with one or two perforation or weakening lines. The perforating station is followed by a cross cutting station, in which individual printed sheets are separated from the material web by cross cutting. The cross cutting station is followed by a longitudinal folding station, in which the sheets are either folded once or twice. A stacking station is arranged behind the longitudinal folding station, in which stacking station the folded sheets are placed on one another to form a stack. Said stacking station has an adhesive application device, by means of which the sheets are provided with an adhesive application or a layer of adhesive before the sheets are placed on one another.

### SUMMARY OF THE INVENTION

When producing book blocks, it may be desired to process printed single sheets. The printed single sheets may have different formats, paper types, grammages, print surfaces, print coverage etc. Therefore, it would be desirable if the book block production line would be able to handle the different features of the printed single sheets when producing a book block therefrom.

It is therefore an object of the invention to provide a sheet processing apparatus for producing book blocks from printed single sheets, a book block production apparatus comprising a sheet processing apparatus, a method of producing book blocks from printed single sheets using a book block production apparatus and a method of processing printed single sheets for producing book blocks therefrom using a sheet processing apparatus, which at least partially improves the prior art and avoids at least part of the disadvantages of the prior art.

According to the present invention, this object is achieved by the features of the independent claims. In addition, further advantageous embodiments follow from the dependent claims and the description as well as the figures.

According to an aspect of the invention, this object is particularly achieved by a sheet processing apparatus for producing pre-glued or loose-sheet book blocks from printed single sheets, comprising a conveying section for conveying a printed single sheet along a conveying direction, an input section configured to receive the printed single sheet from a digital printer or a feeder, a control system configured to generate a workflow order comprising one or more commands for processing the printed single sheet, a sheet sensor arranged at the input section and configured to detect a sheet parameter comprising at least one of position and size of the printed single sheet, a sheet rotator arranged downstream of the sheet sensor and configured to stop the printed single sheet and to rotate the printed single sheet in a plane of the printed single sheet or to convey the printed single sheet without rotation depending on a rotation command of the workflow order, a perforator arranged downstream of the sheet rotator and configured to perforate the printed single sheet along the conveying direction, and a folding device arranged downstream of the perforator and configured to fold the printed single sheet along the perforations generated by the perforator.

The sheet processing apparatus provides the advantage that the need to place or load separate jobs for each book block production can be eliminated by using the workflow order to control the processing of the individual printed sheets. A plurality of workflows may be stored in a workflow storage. The control system generating a workflow order may access the workflow storage and select a workflow in order to generate the workflow order. A workflow order may be generated by the control system upon receiving of a production order by an operator. Generating a workflow order upon receiving a production order may therefore comprise selecting a workflow from a workflow storage. The specific workflow order may depend on the format of the printed single sheets received at the input section which can be detected by the sheet sensor. Therefore, it may not be required to separately specify in each case the format of the printed single sheets in a book block production.

Compared to conventional book block production lines where each production usually requires the placement or loading of a separate job with the indication or specification of sheet parameter and/or printed single sheet information such as its format, position etc., the automation of the book block production can therefore be increased since the book block production can be controlled by means of the workflow order which uses as an input the sheet parameter and/or printed single sheet information provided by the sheet sensor and/or a code reader and/or a printer signal.

The sheet rotator may unconditionally stop and rotate the printed single sheet due to a respective command in the workflow order. The sheet rotator may also conditionally stop and rotate the printed single sheet depending on the format and/or orientation of the printed single sheet as detected by the sheet sensor. The rotation command may also comprise a command that a printed single sheet shall not be rotated. Using the sheet rotator, selective rotation of the printed single sheets can therefore be achieved.

Due to the combination of sheet rotator, perforator and folding device, the sheet processing apparatus can handle different formats of the printed single sheets in a flexible fashion. For example, printed single sheets in A3-format received at the input section in a horizontal orientation where the longer edge of the printed single sheet is parallel to the conveying direction (also known as “short edge feeding”) may be rotated in the sheet rotator by 90° and folded by the folding device in order to obtain a folded sheet in A4-format.

Using the folding device, folded sheets (also known as “signatures”) can be obtained in order to form book blocks therefrom.

The conveying section may extend along the sheet processing apparatus such that at least one of the sheet rotator, the perforator and the folding device may be arranged in the conveying section. Further, the input section may be part of the conveying section.

In some embodiments, the sheet processing apparatus comprises a cutter arranged downstream of the sheet rotator and configured to cut a printed single sheet transverse to the conveying direction, depending on a cutting command of the workflow order.

In some embodiments, the sheet processing apparatus comprises a cutter arranged upstream of the sheet rotator and configured to cut a printed single sheet transverse to the conveying direction, depending on a cutting command of the workflow order.

Using the cutter, a printed single sheet with a large format can be cut. After cutting, the printed single sheet can be folded in order to obtain a folded sheet with the desired format for the book block. The cutting command may also comprise a command that a printed single sheet shall not be cut. The cutting command may be unconditional or conditional depending on the format and/or orientation of the printed single sheet as detected by the sheet sensor.

By arranging the cutter downstream of the sheet rotator, a printed single sheet may be rotated to a desired orientation for cutting. However, a printed single sheet may alternatively be cut before rotation by arranging the cutter upstream of the sheet rotator.

In some embodiments, the sheet processing apparatus comprises an aligner arranged downstream of the sheet rotator and upstream of the perforator, and configured to align a printed single sheet along the conveying direction.

Using the aligner, a printed single sheet can be aligned to have an edge, preferably its shorter edge, parallel to the conveying direction in order to allow proper perforation parallel to the edge, preferably the shorter edge, of the printed single sheet. In particular, the aligner may be arranged at an aligning section of the sheet processing apparatus. The aligner may comprise an alignment ruler arranged at a side of the aligning section and oriented parallel to the conveying direction such that an edge of the printed single sheet may be aligned at the alignment ruler while being conveyed along the conveying direction.

In some embodiments, the folding device is configured to fold a printed single sheet once-only.

In particular, the sheet processing apparatus provides the advantage that the sheet rotator and/or the cutter can process the printed single sheets in a fashion such that the desired format of the book block can be achieved by folding the printed single sheets once-only in order to obtain the required signatures.

In some embodiments, the folding device comprises a horizontally arranged pipe with a bended section bended towards a direction transverse to the conveying direction and emerging with a ramp from a conveying surface of the sheet processing apparatus, such that a first half of a printed single sheet is lifted by sliding onto the ramp and folded onto a second half of the printed single sheet by sliding beneath the bended section.

The conveying surface may be the surface of the conveying section comprising lower drive rollers on which the printed single sheets lie on while being conveyed. The folding device may comprise one or more vacuum belts running below the printed single sheets and conveying the printed single sheets through the folding device. Using the bended pipe, efficient folding of the printed single sheets with a fold parallel to the conveying direction can be provided without having to stop the printed single sheets for the folding action. In particular, the bended pipe is arranged such that the conveying motion can be exploited for folding the printed single sheets. Furthermore, complexity of the folding device can be reduced due to the bended pipe being the main additional component by means of which the folding can be executed. Due to the bended pipe, insight into the folding process by an operator may also be improved compared to prior art solutions with a folding channel and a bended metal plate covering the printed sheets while folding.

In some embodiments, the sheet sensor is configured to determine the size of a printed single sheet, wherein the control system is configured to compare the size determined by the sheet sensor with a target size of the printed single sheet of the workflow order and to determine a size deviation, wherein the sheet rotator and/or the aligner is configured to transversally center the printed single sheet with respect to the perforator using the determined size deviation.

In particular, the sheet sensor may be configured to determine the length and/or width of a printed single sheet. Using the sheet sensor and the control system, a target-actual comparison can therefore be executed in order to obtain the size deviation. By executing the target-actual comparison, changes of format tolerances or enduring format changes can be determined. Furthermore, the target-actual comparison and the size deviation respectively, may be used to determine a shrinkage of a printed single sheet which may occur due to the ink and the drying process while printing. The size deviation may lead to off-centering of the printed single sheet compared to a printed single sheet without size deviation, which may result in an off-centered fold in the folding device. Using the sheet rotator and/or the aligner, the size deviations determined by the sheet sensor and the control system may therefore be corrected such that a centered fold in the folding device can be provided. In particular, the sheet sensor and the control system may provide the option to correct shrinkage effects on the printed single sheets.

In some embodiments, the control system is configured to generate a workflow order comprising one or more commands for processing the printed single sheet using a sheet parameter detected by the sheet sensor and/or using a printer signal, wherein the workflow order is generated by loading from a workflow storage a workflow adapted to the sheet parameter and/or the printer signal.

The control system may therefore receive the sheet parameter detected by the sheet sensor and/or a printer signal from the printer, access the workflow storage having a stored plurality of workflows, to select an applicable workflow based on the sheet parameter and/or the printer signal, and generate a workflow order therefrom.

In some embodiments, the control system is configured to generate a workflow order comprising at least one of: a rotation command, a cutting command, a folding command.

The workflow order may comprise further commands such as one or more of input command, perforation command, collecting command, etc.

In some embodiments, the sheet processing apparatus comprises a code reader arranged at the input section and configured to read sheet information from an identification tag of a printed single sheet, wherein the control system is configured to receive the sheet information from the code reader.

Using the sheet information, the control system may generate a workflow order comprising one or more commands for processing a printed single sheet. The sheet information may comprise information on one or more of color, type, grammage, strength etc. In some embodiments, the code reader may be part of the sheet sensor.

In some embodiments, the code reader is a barcode reader or a data matrix code reader.

The identification tag of a printed single sheet may therefore contain a barcode or a data matrix code which can be read by the code reader.

In some embodiments, the control system is configured to generate a workflow order comprising one or more commands for processing the printed single sheet using a sheet information detected by the code reader, wherein the workflow order is generated by loading from a workflow storage a workflow adapted to the sheet information.

The control system may therefore receive the sheet information detected by the code reader, access the workflow storage having stored a plurality of workflows to select an applicable workflow based on the sheet information, and generate a workflow order therefrom.

In some embodiments, the sheet processing apparatus comprises an adhesive applicator arranged downstream of the folding device and configured to apply an adhesive to a printed single sheet at one or more edges of the printed single sheet or to a folded sheet at one or more edges of the folded sheet.

Using the adhesive applicator, a pre-glued book block of printed single sheets or folded sheets can be produced. Pre-gluing the book blocks provides the advantage that the conveyance and/or transfer of the book blocks to subsequent modules can be improved compared to book blocks where the printed single sheets or folded sheets are loosely stacked. Furthermore, a book block production line using pre-glued book blocks provides the advantage of increased flexibility or adaptability, respectively, compared to book production lines where complete books with covers are produced from single loose sheets.

Preferably, the adhesive applicator is configured to apply the adhesive at an edge of the printed single sheets or folded sheets, preferably an edge which is to be arranged at the spine of a book block.

In some embodiments, the sheet processing apparatus comprises a stacker arranged downstream of the folding device and configured to stack the printed single sheets or folded sheets with the applied adhesive to a pre-glued book block, wherein the adhesive applicator is arranged upstream of or at the stacker.

In some embodiments, the sheet processing apparatus comprises two or more sheet rotators each configured to stop and to rotate the printed single sheet in the plane of the printed single sheet or to convey the printed single sheet without rotation depending on a rotation command of the workflow order.

Using two or more sheet rotators can be particularly advantageous for processing large printed single sheets which may require a sequence of processing steps such as a number of sequential rotations of the printed single sheets.

In particular, the sheet processing apparatus may comprise two or more cutters each arranged downstream of a sheet rotator or upstream of a sheet rotator, and configured to cut the printed single sheet transverse to the conveying direction, depending on a cutting command of the workflow order.

The plurality of sheet rotators and cutters may therefore be arranged sequentially and alternatingly. By arranging a number of sheet rotators and cutters in sequence, a large printed single sheet may run through a sequence of rotating and cutting steps until the desired format for folding is obtained.

According to a further aspect, the present invention is also directed to a book block production apparatus comprising the sheet processing apparatus according to the present disclosure and a digital printer, wherein the digital printer is arranged upstream of the input section of the sheet processing apparatus.

According to a further aspect, the present invention is also directed to a book block production apparatus comprising the sheet processing apparatus according to the present disclosure and a feeder configured to feed a printed single sheet, wherein the feeder is arranged upstream of the input section of the sheet processing apparatus.

According to a further aspect, the present invention is also directed to a method of producing book blocks from printed single sheets using a book block production apparatus according to the present disclosure, the method comprising the steps of: generating by the control system a workflow order comprising one or more commands for processing a printed single sheet; receiving the printed single sheet at the input section of the sheet processing apparatus; detecting by the sheet sensor a sheet parameter comprising at least one of position and size of the printed single sheet; stopping and rotating by the sheet rotator the printed single sheet in the plane of the printed single sheet or conveying the printed single sheet without rotation depending on a rotation command of the workflow order; perforating by the perforator the printed single sheet along the conveying direction; folding by the folding device the printed single sheet along the perforations generated by the perforator.

In some embodiments, the printed single sheet is printed by a digital printer.

In some embodiments, the printed single sheet is fed by a feeder to the input section.

According to a further aspect, the present invention is also directed to a method of processing printed single sheets for producing book blocks therefrom using a sheet processing apparatus according to the present disclosure, the method comprising the steps of: generating by the control system a workflow order comprising one or more commands for processing a printed single sheet; receiving the printed single sheet at the input section of the sheet processing apparatus; detecting by the sheet sensor a sheet parameter comprising at least one of position and size of the printed single sheet; stopping and rotating by the sheet rotator the printed single sheet in the plane of the printed single sheet or conveying the printed single sheet without rotation depending on a rotation command of the workflow order; perforating by the perforator the printed single sheet along the conveying direction; folding by the folding device the printed single sheet along the perforations generated by the perforator.

In some embodiments, the perforated printed single sheet is folded by a horizontally arranged pipe of the folding device with a bended section bended towards a direction transverse to the conveying direction and emerging with a ramp from a conveying surface of the sheet processing apparatus, wherein a first half of the printed single sheet is lifted by sliding onto the ramp and folded onto a second half of the printed single sheet by sliding beneath the bended section.

### BRIEF DESCRIPTION OF THE DRAWINGS

The present invention will be explained in more detail, by way of exemplary embodiments, with reference to the schematic drawings, in which:

FIG. 1 shows a perspective view of an embodiment of a sheet processing apparatus;

FIG. 2 shows a top view of a part of an embodiment of a sheet processing apparatus;

FIG. 3 shows a perspective view of a part of the embodiment of a sheet processing apparatus of FIG. 2;

FIG. 4 shows an enlarged perspective view of the embodiment of a folding device of FIG. 3;

FIG. 5 shows a perspective view of a part of an embodiment of a sheet processing apparatus.

### DETAILED DESCRIPTION OF EXEMPLARY EMBODIMENTS

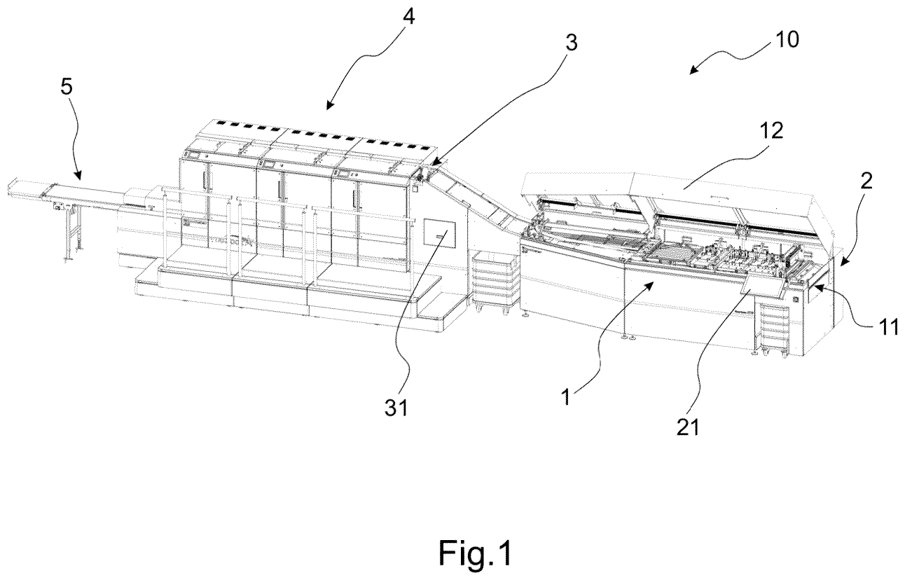

FIG. 1 shows a perspective view of an embodiment of a sheet processing apparatus 10 for producing pre-glued book blocks from printed single sheets. The sheet processing apparatus 10 comprises a conveying section 1 for conveying the printed single sheets along a conveying direction. The conveying section 1 comprises at its upstream end an input section 11 for receiving the printed single sheets from a digital printer or a feeder which may be connected to the upstream end of the input section 11. The sheet processing apparatus 10 comprises a control system 2 configured to generate a workflow order comprising one or more commands for processing the printed single sheets. The control system 2 is arranged in a control cabinet arranged at a rear side of the sheet processing apparatus 10. The control system 2 further comprises a control panel 21 for an operator. The operator may input or select a production order using the control panel 21. In some embodiments, the control system 2 may remotely be arranged and connected to the sheet processing apparatus 10. The conveying section 1 comprises a hood 12 which is closed during operation of the sheet processing apparatus 10.

At a downstream end of the conveying section 1, there is arranged an adhesive applicator 3 in which the printed single sheets or folded sheets are applied with an adhesive at one or more edges. The adhesive applicator 3 is arranged downstream to a slope under which a tank 31 with a supply of adhesive is arranged. The tank 31 comprises a door for accessing the adhesive supply.

Downstream to the adhesive applicator 3, there is arranged a stacker 4 configured to stack the printed single sheets or folded sheets to pre-glued book blocks which are output at an output section 5.

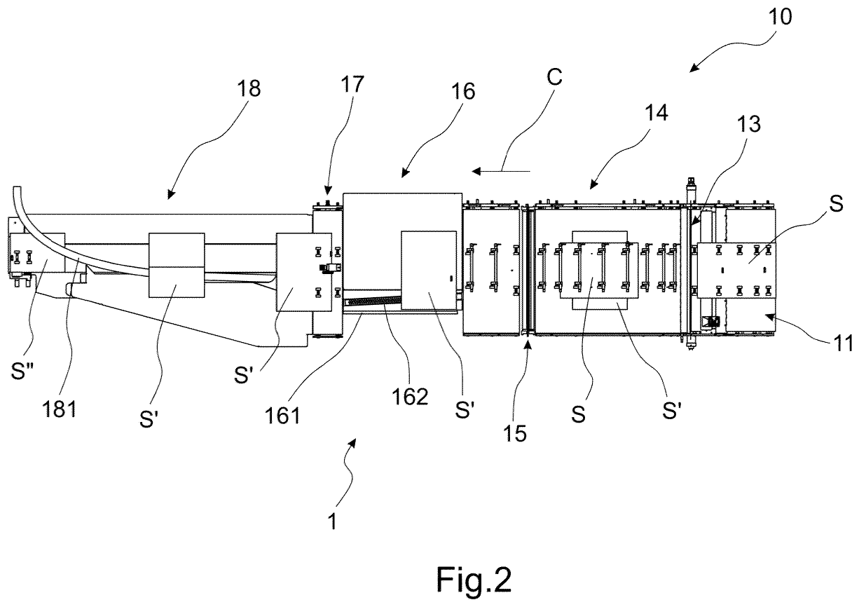

FIG. 2 shows a top view of a part of an embodiment of a sheet processing apparatus 10. A printed single sheet S is received at the input section 11. The printed single sheets S, S′, S″ are conveyed in a conveying direction C of the conveying section 1. The printed single sheet S received at the input section 11 passes a sheet sensor 13 arranged at the input section. The sheet sensor 13 determines a sheet parameter comprising position and/or size of the printed single sheet S without stopping the printed single sheet S. Depending on the determined position and/or size of the printed single sheet S and a rotation command of a respective workflow order, a sheet rotator 14 may stop and rotate the printed single sheet S or convey the printed single sheet S without rotation. In the shown example, a printed single sheet S which arrives at the sheet rotator 14 with its longer edge parallel to the conveying direction C (i.e. in short edge feeding), is stopped and rotated by the sheet rotator 14 by 90°. The rotated printed single sheet is denoted by S′ and has its shorter edge parallel to the conveying direction C.

The rotated printed single sheet S′ is further conveyed in the conveying direction C and passes a cutter 15 where the printed single sheet S′ may be cut depending on a cutting command of the workflow order. Downstream to the cutter 15, there is arranged an aligner 16 where the shorter edge of the printed single sheet S′ is aligned to an alignment ruler 161. The aligner 16 comprises a vacuum belt 162 which has a slanted orientation towards the alignment ruler 161 such that the printed single sheet S′ is imposed with a transversal conveying motion additional to the conveying motion in the conveying direction C and pushed towards the alignment ruler 161.

After being aligned by the aligner 16, the printed single sheet S′ passes a perforator 17 where the printed single sheet S′ is perforated along the conveying direction C. Downstream to the perforator, there is arranged a folding device 18 where the perforated printed single sheet S′ is folded along the perforations generated by the perforator.

The folding device 18 comprises a pipe 181 which is bended towards a direction transverse to the conveying direction and essentially in the plane of the conveying surface of the sheet processing apparatus 10. The folded sheet S″ is conveyed further passing below the pipe 181.

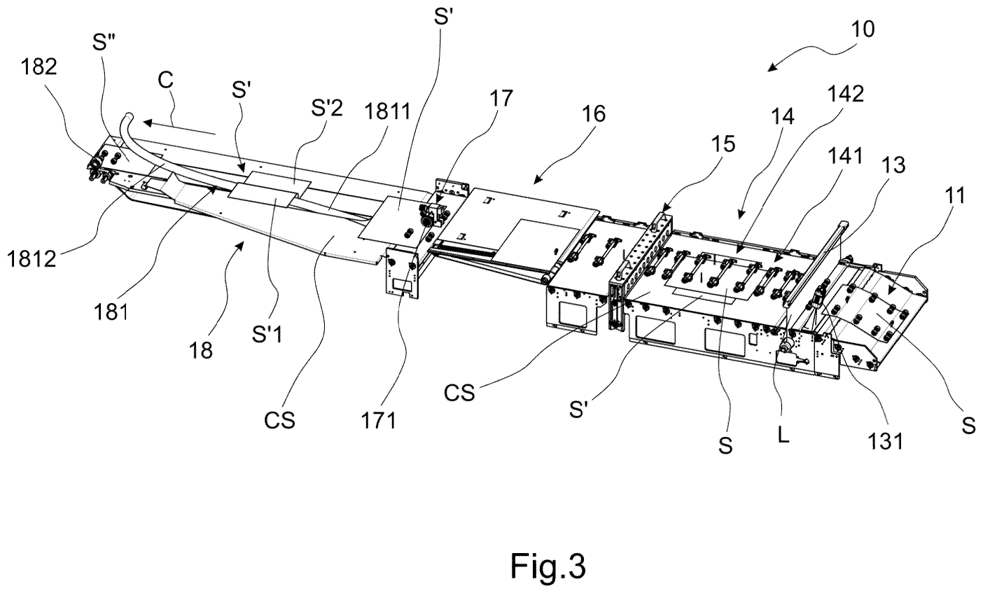

FIG. 3 shows a perspective view of a part of an embodiment of the sheet processing apparatus 10 of FIG. 2. The input section 11 comprises a ramp on which a printed single sheet S are received. The sheet sensor 13 determines the position and/or size of the printed single sheet S passing the sheet sensor 13. For illustrating the sensing of the sheet sensor 13, a light curtain L is shown in FIG. 3. At the input section, there is arranged a code reader 131 which reads sheet information from a printed identification tag of the printed single sheet S. The code reader 131 may be, in a variant, integrated with the sheet sensor 13. The control system may use the sheet information determined by the code reader 131 for generating the workflow order, in addition to the position and/or size of the printed single sheet S, as determined by the sheet sensor 13.

The sheet rotator 14 comprises a plurality of subsequently arranged pair of rollers 141 which serve to keep the printed single sheet S on lower-lying drive rollers of the conveying surface CS and to convey and stop the printed single sheet S. The lower-lying rollers are arranged at the conveying surface CS and below the printed single sheets. The printed single sheet S is stopped and rotated by rotating the rollers of a pair of lower-lying drive rollers in opposite directions. While rotating the printed single sheet, the rollers 142 arranged above the lower-lying drive rollers used for rotating the printed single sheet are lifted in order to allow rotation of the printed single sheet. The rotated printed single sheet is illustratively shown by the printed single sheet S′ (which, in as shown in FIG. 3, is not meant to be an additional printed single sheet S′ arranged below the printed single sheet S).

The perforator 17 arranged downstream to the aligner 16 applies a perforation along the longitudinal central axis of the printed single sheet S′ by means of a perforation roller 171, as can be recognized in FIG. 3.

The horizontally arranged pipe 181 of the folding device 18 emerges with a ramp 1811 from the conveying surface CS of the folding device 18. Further, the ramp 1811 is arranged next to the longitudinal central axis of the printed single sheet S′ such that a first half S′1 of the printed single sheet S′ is lifted by sliding onto the ramp 1811 and folded onto a second half S′2 of the printed single sheet S′ by sliding beneath the bended section 1812 when being conveyed further in the conveying direction C. On the conveying surface CS of the folding device 18, the printed single sheet S′ and, in particular, its second half S′2 is conveyed and held by one or more vacuum belts (not shown in FIG. 3). The folded sheet S″ is conveyed further passing below the bended section 1812 of the pipe 181. At the outfeed of the folding device 18, a press roller 182 presses on the fold of the folded sheet S″ such that an accurate fold can be obtained.

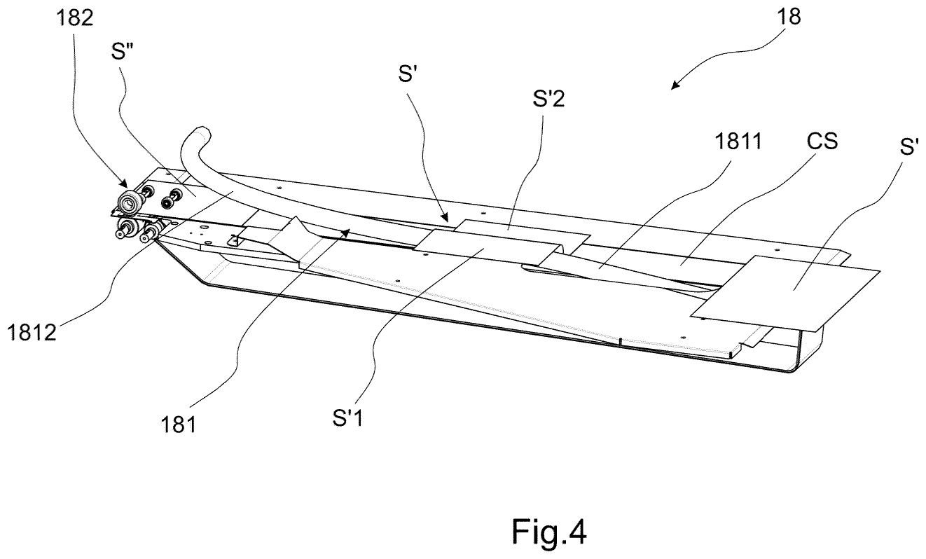

FIG. 4 shows an enlarged perspective view of the embodiment of a folding device 18 of FIG. 3. The folding process where the printed single sheet S′ arrives from the perforator (not shown in FIG. 4), the first half S′1 is lifted by sliding onto the ramp 1811 of the pipe 181 and folded onto the second half S′2 by sliding beneath the bended section 1812 such that a folded sheet S″ is obtained, can be recognized. The folded sheet S″ is conveyed further by passing below the bended section 1812 of the pipe 181 whereby a press roller 182 presses on the fold of the folded sheet S″ such that a clean fold is obtained.

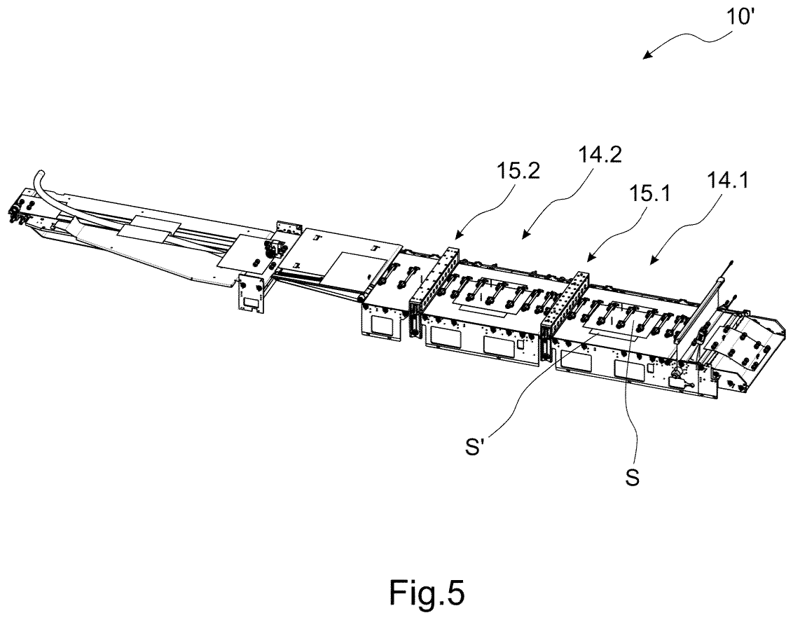

FIG. 5 shows a perspective view of a part of an embodiment of a sheet processing apparatus 10′. The structure of the sheet processing apparatus essentially corresponds to the embodiment of the sheet processing apparatus 10 as shown in FIG. 3. Compared to the embodiment shown in FIG. 3, however, the sheet processing apparatus 10′ comprises two sequentially arranged sheet rotators 14.1 and 14.2. The rotation steps are symbolized for each sheet rotator 14.1, 14.2 by two overlapping printed single sheets S, S′, similar to the illustration in FIG. 3. The sheet processing apparatus 10′ further comprises two cutters 15.1 and 15.2 which are each arranged downstream to a sheet rotator 14.1, 14.2. Using the sheet processing apparatus 10′, a sequence of rotating and cutting steps can be executed on a printed single sheet S. This may particularly be advantageous for large printed single sheets. For example, a printed single sheet of a B2-format fed in short edge feeding may pass the first sheet rotator 14.1 without being rotated. The first cutter 15.1 may then cut the B2-format printed single sheet transverse to the conveying direction such that two consecutive printed single sheets of A3-format may be obtained which are conveyed in long edge feeding to the second sheet rotator 14.2. The printed single sheets of A3-format may then be rotated in the second sheet rotator 14.2 and conveyed in short edge feeding to the second cutter 15.2. The second cutter 15.2 may then cut the printed single sheets of A3-format such that printed single sheets of A4-format are obtained. The printed single sheets of A4-format are conveyed further to the folding device in long-edge feeding where the printed single sheets of A4-format are folded in order to obtain signatures of A5-format.

1. A sheet processing apparatus for producing pre-glued or loose-sheet book blocks from printed single sheets, comprising a conveying section for conveying a printed single sheet along a conveying direction, an input section configured to receive the printed single sheet from a digital printer or a feeder, a control system configured to generate a workflow order comprising one or more commands for processing the printed single sheet, a sheet sensor arranged at the input section and configured to detect a sheet parameter comprising at least one of position and size of the printed single sheet, a sheet rotator arranged downstream of the sheet sensor and configured to stop the printed single sheet and to rotate the printed single sheet in a plane of the printed single sheet or to convey the printed single sheet without rotation depending on a rotation command of the workflow order, a perforator arranged downstream of the sheet rotator and configured to perforate the printed single sheet along the conveying direction, and a folding device arranged downstream of the perforator and configured to fold the printed single sheet along the perforations generated by the perforator.

2. The sheet processing apparatus according to claim 1, comprising a cutter arranged downstream of the sheet rotator and configured to cut the printed single sheet transverse to the conveying direction, depending on a cutting command of the workflow order.

3. The sheet processing apparatus according to claim 1, comprising a cutter arranged upstream of the sheet rotator and configured to cut the printed single sheet transverse to the conveying direction, depending on a cutting command of the workflow order.

4. The sheet processing apparatus according to claim 1, comprising an aligner arranged downstream of the sheet rotator and upstream of the perforator, and configured to align the printed single sheet along the conveying direction.

5. The sheet processing apparatus according to claim 1, wherein the folding device is configured to fold the printed single sheet once-only.

6. The sheet processing apparatus according to claim 1, wherein the folding device comprises a horizontally arranged pipe with a bended section bended towards a direction transverse to the conveying direction and emerging with a ramp from a conveying surface of the sheet processing apparatus, such that a first half of the printed single sheet is lifted by sliding onto the ramp and folded onto a second half of the printed single sheet by sliding beneath the bended section.

7. The sheet processing apparatus according to claim 1, wherein the sheet sensor is configured to determine the size of the printed single sheet, wherein the control system is configured to compare the size determined by the sheet sensor with a target size of the printed single sheet of the workflow order and to determine a size deviation, wherein the sheet rotator and/or the aligner is configured to transversally center the printed single sheet with respect to the perforator using the determined size deviation.

8. The sheet processing apparatus according to claim 1, wherein the control system is configured to generate a workflow order comprising one or more commands for processing the printed single sheet using a sheet parameter detected by the sheet sensor and/or using a printer signal, wherein the workflow order is generated by loading from a workflow storage a workflow adapted to the sheet parameter and/or the printer signal.

9. The sheet processing apparatus according to claim 1, wherein the control system is configured to generate a workflow order comprising at least one of: a rotation command, a cutting command.

10. The sheet processing apparatus according to claim 1, comprising a code reader arranged at the input section and configured to read sheet information from an identification tag of the printed single sheet, wherein the control system is configured to receive the sheet information from the code reader.

11. The sheet processing apparatus according to claim 10, wherein the code reader is a barcode reader or a data matrix code reader.

12. The sheet processing apparatus according to claim 10, wherein the control system is configured to generate a workflow order comprising one or more commands for processing the printed single sheet using a sheet information detected by the code reader, wherein the workflow order is generated by loading from a workflow storage a workflow adapted to the sheet information.

13. The sheet processing apparatus according to claim 1, comprising an adhesive applicator arranged downstream of the folding device and configured to apply an adhesive to the printed single sheet at one or more edges of the printed single sheet or to a folded sheet at one or more edges of the folded sheet.

14. The sheet processing apparatus according to claim 13, comprising a stacker arranged downstream of the folding device and configured to stack the printed single sheets or folded sheets with the applied adhesive to a pre-glued book block, wherein the adhesive applicator is arranged upstream of or at the stacker.

15. The sheet processing apparatus according to claim 1, comprising two or more sheet rotators each configured to stop and to rotate the printed single sheet in the plane of the printed single sheet or to convey the printed single sheet without rotation depending on a rotation command of the workflow order.

16. The sheet processing apparatus according to claim 15, comprising two or more cutters each arranged downstream of a sheet rotator or upstream of a sheet rotator, and configured to cut the printed single sheet transverse to the conveying direction, depending on a cutting command of the workflow order.

17. A book block production apparatus comprising the sheet processing apparatus according to claim 1 and a digital printer, wherein the digital printer is arranged upstream of the input section of the sheet processing apparatus.

18. A book block production apparatus comprising the sheet processing apparatus according to claim 1 and a feeder configured to feed printed single sheets, wherein the feeder is arranged upstream of the input section of the sheet processing apparatus.

19. A method of producing book blocks from printed single sheets using a book block production apparatus according to claim 17, the method comprising the steps of: generating by the control system a workflow order comprising one or more commands for processing a printed single sheet; receiving the printed single sheet at the input section of the sheet processing apparatus; detecting by the sheet sensor a sheet parameter comprising at least one of position and size of the printed single sheet; stopping and rotating by the sheet rotator the printed single sheet in the plane of the printed single sheet or conveying the printed single sheet without rotation depending on a rotation command of the workflow order; perforating by the perforator the printed single sheet along the conveying direction; folding by the folding device the printed single sheet along the perforations generated by the perforator.

20. The method according to claim 19, wherein the printed single sheet is printed by a digital printer.

21. The method according to claim 19, wherein the printed single sheet is fed by a feeder to the input section.

22. A method of processing printed single sheets for producing book blocks therefrom using a sheet processing apparatus according to claim 1, the method comprising the steps of: generating by the control system a workflow order comprising one or more commands for processing a printed single sheet; receiving the printed single sheet at the input section of the sheet processing apparatus; detecting by the sheet sensor a sheet parameter comprising at least one of position and size of the printed single sheet; stopping and rotating by the sheet rotator the printed single sheet in the plane of the printed single sheet or conveying the printed single sheet without rotation depending on a rotation command of the workflow order; perforating by the perforator the printed single sheet along the conveying direction; folding by the folding device the printed single sheet along the perforations generated by the perforator.

23. The method according to claim 22, wherein the perforated printed single sheet is folded by a horizontally arranged pipe of the folding device with a bended section bended towards a direction transverse to the conveying direction and emerging with a ramp from a conveying surface of the sheet processing apparatus, wherein a first half of the printed single sheet is lifted by sliding onto the ramp and folded onto a second half of the printed single sheet by sliding beneath the bended section.
